(19) United States
(12) Patent Application Publication
(10) Pub. No.: US 2026/0336392 A1
(43) Pub. Date: Oct. 29, 2026

(54) ELECTRIC DRIVE SYSTEM HAVING MULTIPLE COMPLEMENTARY REDUCERS

(71) Applicants: FCA US LLC, Auburn Hills, MI (US); Stellantis Auto SAS, Poissy (FR)

(72) Inventors: Lucien Duplessis, III, Auburn Hills, MI (US); Mark A. Levine, Auburn Hills, MI (US)

(21) Appl. No.: 19/191,304

(22) Filed: Apr. 28, 2025

(51) Int. Cl. B60K 17/04; B60K 1/02; F16H 1/46

(52) U.S. Cl. CPC B60K 17/046; B60K 1/02; F16H 1/46

(57) ABSTRACT

An electric drive system for an electrified vehicle includes a driveline, a first electric drive module, and a first gear reduction assembly. The driveline includes a first drive shaft that drives a first drive wheel and a second drive shaft that drives a second drive wheel. The first electric drive module has a first primary output shaft. The first gear reduction assembly comprises a first gear reduction unit driven by the first primary output shaft; and a second gear reduction unit provided at the first drive wheel, the first and second gear reduction units providing a collective gear reduction from the first primary output shaft, through the first gear reduction unit, through the first drive shaft, through the second gear reduction and to a first wheel shaft at the first drive wheel.

### FIELD

The present application relates generally to electric drive systems for electric vehicles and, more particularly, to an electric drive system that incorporates a first gear reducer arranged at the drive module assembly and a second reducer arranged at a drive wheel for a given driven axle.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) converter.

Electric vehicles can have electric motors configured in various arrangements. Some electric vehicles have a single electric motor dedicated to a drive axle. All-wheel-drive electric vehicles can have multiple electric motors such as one or more dedicated to a front and/or rear drive axle. Some arrangements include a dedicated electric motor for each drive wheel. Regardless of the arrangement, it can be desirable to provide a configuration that offers suitable drive torque depending upon vehicle type. In doing so, it can be challenging to configure an electrified powertrain for high torque and high power electric motors as the packaging requirements can be a limiting factor. Moreover, existing configurations do not allow for modularity when more than one configuration may be desired for the same vehicle type. Additionally, gear reduction options are addressed by simply using a different EDM that houses a different reducer. While this approach reduces the number of parts, it increases EDM complexity overall. Accordingly, while such electrified powertrains work well for their intended purpose, there is a desire for improvement in the relevant art.

### SUMMARY

In accordance with one example aspect of the invention, an electric drive system for an electrified vehicle includes a driveline, a first electric drive module, and a first gear reduction assembly. The driveline includes a first drive shaft that drives a first drive wheel and a second drive shaft that drives a second drive wheel. The first electric drive module has a first primary output shaft. The first gear reduction assembly comprises a first gear reduction unit driven by the first primary output shaft; and a second gear reduction unit provided at the first drive wheel, the first and second gear reduction units providing a collective gear reduction from the first primary output shaft, through the first gear reduction unit, through the first drive shaft, through the second gear reduction and to a first wheel shaft at the first drive wheel.

In addition to the foregoing, the electric drive system further includes a second gear reduction assembly. The second gear reduction assembly includes: a third gear reduction unit driven by a second primary output shaft of the first electric drive module; and a fourth gear reduction unit provided at the second drive wheel, the third and fourth gear reduction units providing a collective gear reduction from the second primary output shaft, through the third gear reduction unit, through the second drive shaft, through the fourth gear reduction unit and to a second wheel shaft at the second drive wheel.

In additional features, the first, second, third and fourth gear reduction units are modular and removable relative to the respective drive axles, drive wheels and first electric drive module.

In other implementations, the second gear reduction unit is a planetary reducer that comprises a first housing that houses a planetary gear set including a sun gear, a carrier that supports a plurality of pinion gears, and a ring gear.

In other examples, the electric drive system further comprises a first coupling that couples the first drive shaft to the sun gear.

In additional implementations, the fourth gear reduction unit is a planetary reducer that comprises a second housing that houses a planetary gear set including a sun gear, a carrier that supports a plurality of pinion gears, and a ring gear.

In addition to the foregoing, the electric drive system further comprises a first bearing that supports the sun gear.

In addition to the foregoing, the electric drive system further comprises at least one second bearing that supports the first wheel shaft.

In examples, the electric drive system further includes a second electric motor; and a third electric motor positioned between the first and second electric motors.

In other implementations, the first, second and third electric motors are co-axially arranged on a rear axle of the electrified vehicle.

In additional examples, the first, second and third electric motors are co-axially arranged on a front axle of the electrified vehicle.

In other configurations, the first electric motor drives the first drive shaft and the second electric motor drives the second drive shaft, the first and second electric motors providing torque vectoring between the first and second drive wheels.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric drive system including first, second and third (center) axially arranged electric drive modules (EDM's), the electric drive system having a first gear reduction assembly associated with a first drive axle and a second gear reduction assembly associated with a second drive axle, each gear reduction assembly including a first gear reduction unit adjacent the drive module assembly and a second gear reduction unit at a drive wheel, in accordance with one implementation of the present application;

FIG. 2 is a schematic illustration of an example electric drive system having a single EDM and including a first gear reduction assembly associated with a first drive axle and a second gear reduction assembly associated with a second drive axle, each gear reduction assembly including a first gear reduction unit adjacent the drive module assembly and a second gear reduction unit at a drive wheel, in accordance with another implementation of the present application;

FIG. 3 is a front perspective view of the drive module system shown in FIG. 1, shown in a first configuration with all of the first, second and third motors operably coupled, in accordance with the principles of the present application;

FIG. 4 is a front perspective view of the drive module system shown in FIG. 1, shown in a second configuration with the center electric motor removed, in accordance with the principles of the present application;

FIG. 5 is a sectional view of the second gear reduction unit at a drive wheel of FIG. 1;

FIG. 6 represents sectional views of a plurality of second gear reduction units each having a different gear reduction; and

FIG. 7 is a perspective view of a plurality of first gear reduction units each having a different gear reduction.

### DETAILED DESCRIPTION

As noted above, it can be desirable to provide an electric motor configuration that offers suitable drive torque depending upon vehicle type. In doing so, it can be challenging to configure an electrified powertrain for high torque and high power electric motors as the packaging requirements can be a limiting factor. Moreover, existing configurations do not allow for modularity when more than one configuration may be desired for the same vehicle type. Additionally, gear reduction options are typically addressed by simply using a different EDM that houses a different reducer. While this approach reduces the number of parts, it increases EDM complexity overall.

The present disclosure provides a first gear reduction assembly associated with a first drive axle and a second gear reduction assembly associated with a second drive axle. Each gear reduction assembly includes two distinct (e.g., separate) gear reduction units. In particular, the first and second gear reduction assemblies each include (i) a first gear reduction unit adjacent the drive module assembly and (ii) a second gear reduction unit at the drive wheel. The configuration disclosed herein provides driveline modularity. By splitting the reduction assemblies into two parts, high levels of gear reductions are more feasible for powertrains that have strict packaging requirements. Vehicles requiring high gear reductions often have significant packaging issues due to the larger reducer assembly attached to the EDM. The present disclosure overcomes this disadvantage by splitting the reductions between two gear reduction units per drive axle.

The configurations herein promote modularity and ease of serviceability. In this regard, either of the reducers at the EDM or at the wheels can be swapped out to achieve a desired total gear reduction (gear reduction multiplication from the two gear reduction units (per axle)) from the EDM to the drive wheel. Furthermore, the gear reduction units will be accessible for service, replacement, or modification without the need to remove or disassemble the powertrain. Moreover, the present disclosure solves gear reduction complexity issues when a single EDM is intended to be used in a large variety of vehicle platforms. With this system, the EDM can remain common while the gear reduction units can be chosen based on performance objectives for a specific vehicle type.

By way of example, the electric motors can be any electric motors including axial flux motors, radial flux motors and other electric motors, or a combination of different motor topologies. While the examples herein are axial flux motors, the requirements could also be met with appropriately designed motors of different topology (e.g., radial flux, transverse flux, or some other different configuration). In a first configuration, three motors are arranged co-axially in series. As axial flux motors take up significantly less space (axially), three motors are arranged co-axially side-by-side and can collectively fit between the rails of most allowable packaging spaces. The center motor of the three axial motors includes an internal differential. The three axial flux motor configuration can be particularly suitable in high performance vehicles. The three axial flux motor configuration can be incorporated at the rear axle and/or the front axle and would include controls that optimize the torque and power as well as efficiency for a given accelerator pedal request. The electric drive system further provides a gear reduction (e.g., wheel reducer) system having in-wheel reducers that can be changed and/or customized to meet specific vehicle needs to satisfy low speed torque or top end speed. In additional implementations, the in-wheel reducers can be two-speed reducers allowing the configuration to balance a maximum vehicle speed and low speed torque requirements as needed. The drive module can also be adapted in a second configuration where the center motor is removed leaving two axial flux motors.

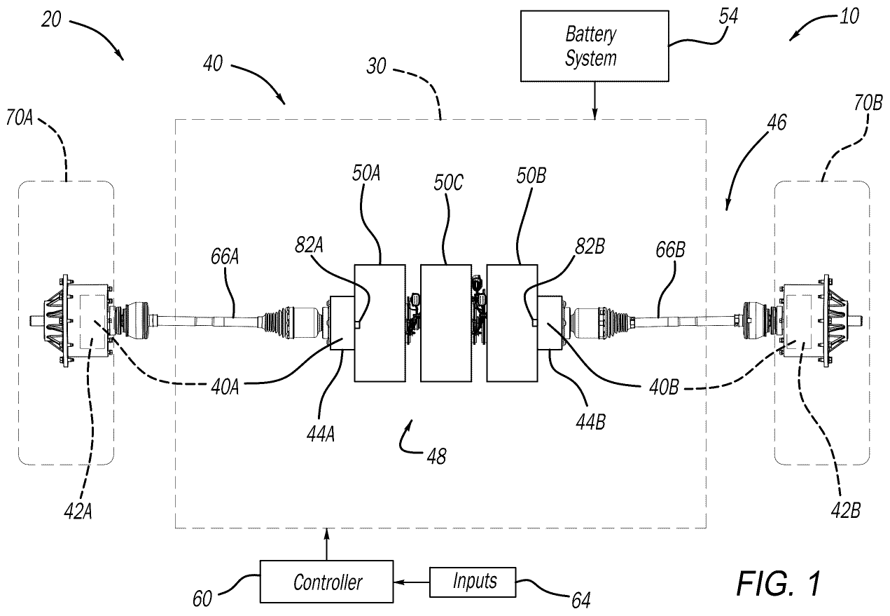

With initial reference to FIG. 1, a vehicle 10 is partially shown in accordance with the principles of the present disclosure. In the example embodiment, vehicle 10 includes an electric drive system 20 having a drive module system 30 and a gear reduction assembly, collectively identified at reference numeral 40 and individually identified at a first gear reduction assembly 40A associated with a first drive axle 66A and a second gear reduction assembly 40B associated with a second drive axle 66B. The drive module system 30 is configured to generate and transfer drive torque through the drive axles 66A, 66B and to a driveline 46 for vehicle propulsion.

The drive module system 30 is shown in a first configuration having an electric motor assembly 48 including a first electric drive motor 50A, a second electric drive motor 50B and a third electric drive motor 50C. In the first configuration, the first and second drive motors 50A and 50B are arranged on opposing axial sides of the third, or center, drive motor 50C. The electric motors 50A-50C are connectable via a power inverter module (not specifically shown) to a high voltage battery system 54. A controller 60 can communicate signals to the drive module system 30 indicative of a torque request based on inputs 64 (e.g., such as from an accelerator pedal). While the electric motors 50A-50C are described herein as axial flux motors, it will be appreciated that other motor configurations such as, but not limited to, radial flux motors may be used.

The exemplary driveline 46 includes the first drive shaft 66A, the second drive shaft 66B, the gear reduction assembly 40 and drive wheels 70A and 70B. The first gear reduction assembly 40A includes a first gear reduction unit 44A adjacent to (and driven by a primary output shaft 82A of) the electric motor 50A of the electric motor assembly 48, and a second gear reduction unit 42A (also referred to herein as a “wheel reducer”) at the drive wheel 70A. The second gear reduction assembly 40B includes a third gear reduction unit 44B adjacent to (and driven by a primary output shaft 82B of) the electric motor 50B of the electric motor assembly 48 and a fourth gear reduction unit or wheel reducer 42B at the drive wheel 70B.

A total reduction provided by the first gear reduction assembly 40A is determined by multiplying the gear reductions of the first and second gear reduction units 44A, 42A. By splitting the gear reduction capacity between the two gear reduction units 44A and 42A, a total gear reduction can be achieved (from the motor output to the drive wheel 70A) without requiring a singular packaging space to accommodate one large gear reduction unit. Similarly, a total reduction provided by the second gear reduction assembly 40B is determined by multiplying the gear reductions of the third and fourth gear reduction units 44B, 42B. By splitting the gear reduction capacity between the two gear reduction units 44B and 42B, a total gear reduction can be achieved (from the motor output to the drive wheel 70B) without requiring a singular packaging space to accommodate one large gear reduction unit.

In the examples shown, the gear reduction units 44A, 44B, 42A, and 42B can provide predetermined gear ratios selected for various vehicle types. For example, but not limited to, gear ratios of 2:1, 3:1, 4:1, 5:1, 6:1 and others may be used. The gear ratios at any of the gear reduction units 44A, 44B, 42A, and 42B can be achieved with any gearing arrangement such as, but not limited to planetary gear sets. As will become appreciated herein, the wheel reducers 42A, 42B can be swapped out for other wheel reducers having different gear ratios that may be particularly suited for a particular vehicle application. Similarly, the gear reduction units 44A and/or 44B can be swapped out for other gear reduction units having different gear ratios that may be particularly suited for a particular vehicle application.

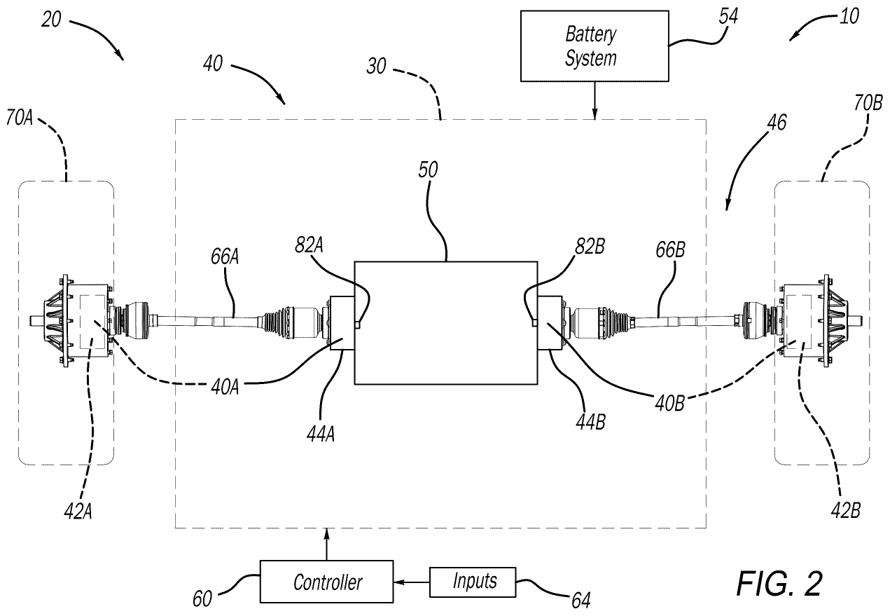

Referring now to FIG. 2, a schematic illustration of an example electric drive system including a drive module system having a first electric drive module (EDM). The electric drive system is constructed similarly to the electric drive system described above with respect to FIG. 1 except only one electric motor 50 is provided. In this regard, the gear reduction assembly 40 disclosed herein is applicable to any EDM configuration having one electric motor, or more than one electric motor.

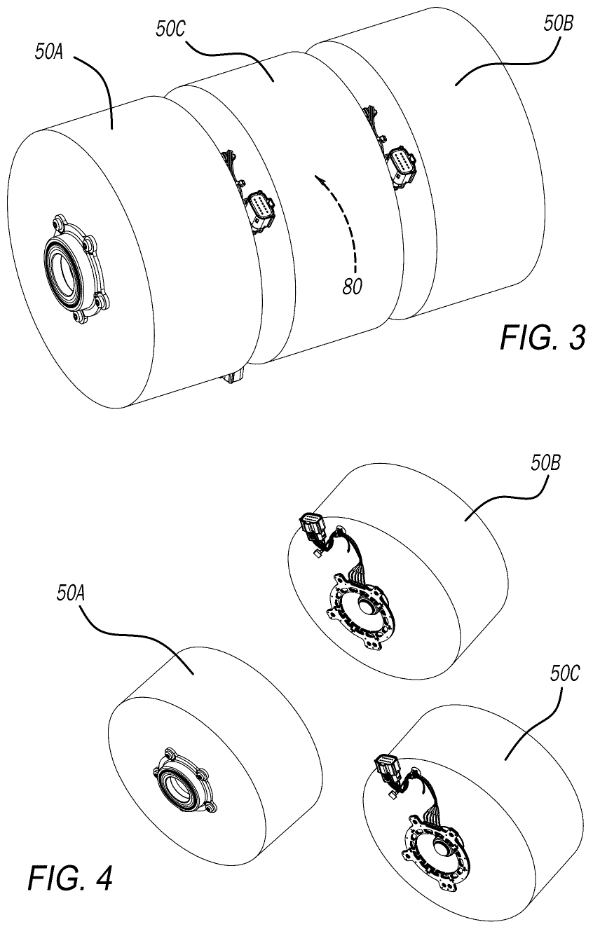

With continued reference to FIG. 1 and additional reference to FIGS. 3 and 4, additional features of the instant disclosure will be described. FIG. 3 is a front perspective view of the drive module system shown in FIG. 1, shown in a first configuration with all of the first, second and third motors 50A, 50B and 50C operably coupled. FIG. 4 is a front perspective view of the drive module system shown in FIG. 1, shown in a second configuration with the center motor 50C removed. Having two outboard electric motors 50A, 50B going directly to each wheel 70A, 70B allows for torque vectoring while the third center motor 50C adds torque and power to the system without compromising the torque vectoring capabilities.

The electric drive system 20 is modular and easily adaptable to configure dependent upon vehicle type. In this regard it is contemplated that an electric drive system 20 can be used in multiple configurations such as a first configuration (FIG. 3) in a high performance vehicle (such as using all three coaxial motors and appropriately geared wheel reducers), or in a second configuration (FIG. 4) in a lower power application, such as by using only the two motors 50A and 50B without the center motor 50C and appropriately geared wheel reducers.

As mentioned herein, the electric drive system 20 can be configured on either a front or rear drive axle of the driveline 46. In some configurations, the electric drive system 20 can be arranged on both the front and rear drive axles for a four-wheel drive or all-wheel drive driveline vehicle.

As described above, the electric motors 50A, 50B and 50C are axial flux motors. Axial flux motors can be larger in diameter but significantly less wide (axially) while achieving power and torque levels of a radial flux motor (which is the architecture used in most electric vehicles). The in-wheels reducers 40A, 40B significantly reduce the packaging space required for the electric motors as a portion of the gearing (in addition to the gear reduction provided by the gear reducers 44A and 44B at the motor output) is performed in the wheels 70A, 70B, rather than exclusively at the motor housing. This advantage allows end users to target specific performance needs based on their individual requirements. For example, high performance vehicle drivers may want to modify their vehicles for many purposes, such as, but not limited to, drag racing, track racing, daily driving, economy driving etc.

Similarly, off-road vehicle drivers can have various off-road gearsets based on vehicle weight as well as ratios for daily travel. In examples, a user may install an economy gearset wheel reducer system 42A, 42B to get to the trail and subsequently change the wheel reducer system to increase the torque available for off-roading. This availability eliminates the need for a two speed gearbox. An off-road gearset would only “need” to be purchased if desired by the user. This eliminates being limited to the one or two speed gearbox selection at the time of original vehicle purchase for the life of the vehicle. The drive module system 30 allows for future electric motor designs that may have significantly more power and torque.

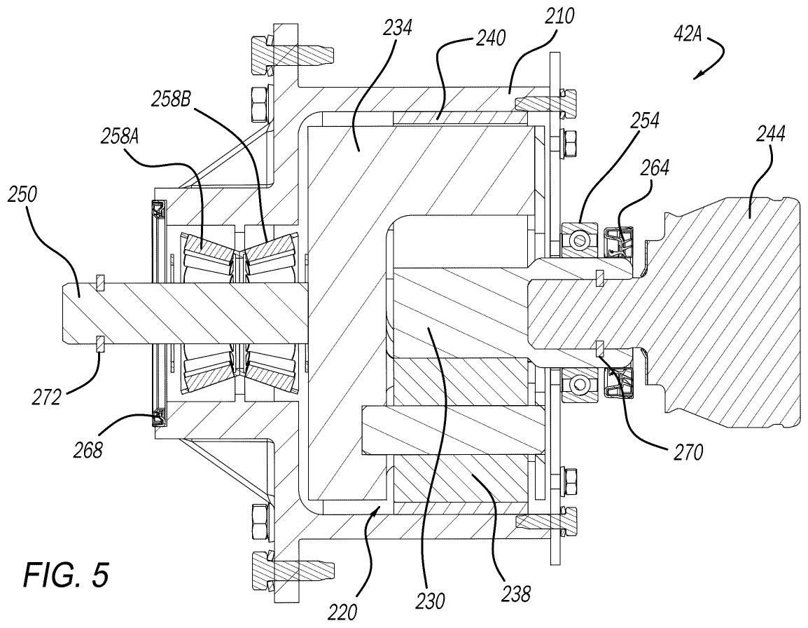

With additional reference now to FIG. 5, additional features of the second gear reduction unit 42A associated with the first drive axle 66A will be described. It will be appreciated that the second gear reduction unit 42B associated with the second drive axle 66B can be similarly constructed. The second gear reduction unit 42A 40 is packaged in the drive wheel 70A. In this regard, and as shown in FIG. 1, a second gear reduction unit 42A is packaged at first drive wheel 70A and the second wheel-end planetary reducer 42B is packaged at second drive wheel 70B. By packaging the gear reduction units 42A, 42B at the wheel, more room is created for the electric motors 50 and the first gear reduction units 44A, 44B, in the center of the vehicle. Furthermore, the torque being transferred through the propeller/constant velocity (CV) shafts is reduced which allows them to be downsized to reduce weight and material costs. The configuration permits the easy removal and installation of the reducer to provide modularity for different gear ratio reducer modules. The configuration allows for servicing or replacement of the gearsets (i.e., gear ratio), or simply swapping from one planetary module to another. The configuration permits a narrower spring-mass chassis and longer control arms, which is a key enabler for chassis tuning.

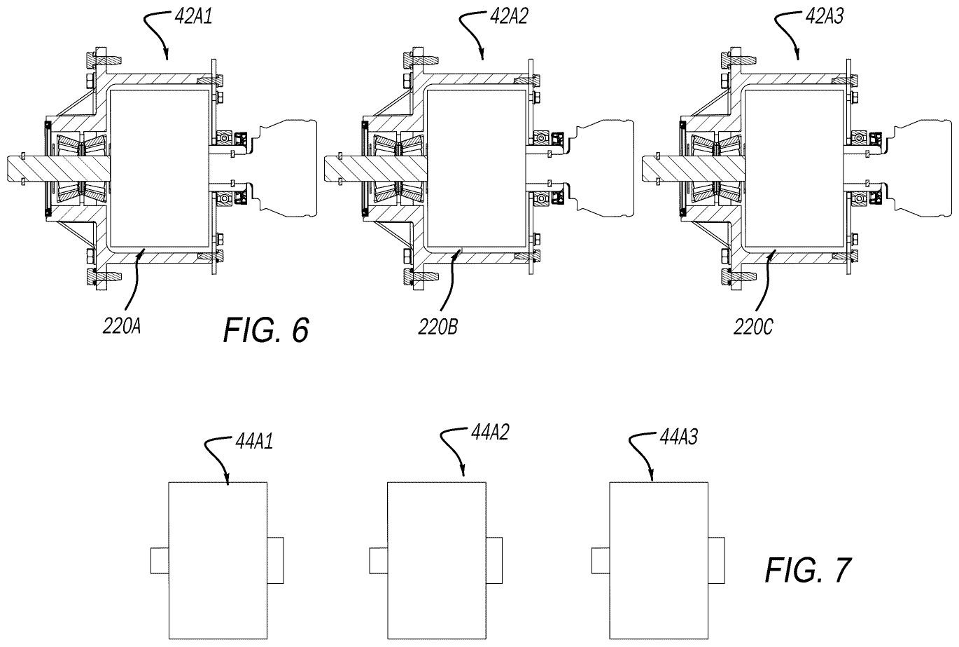

The second gear reduction unit 42A generally includes a housing 210 that houses a planetary gear set 220. The planetary gear set 220 can have various reduction ratios such as, but not limited to, 4:1, 5:1, 6:1, 7:1, 8:1 or 9:1. Other ratios may be used. By way of example only, FIG. 6 illustrates three second gear reduction units 42A1, 42A2 and 42A3, each having a distinct gear ratio offered by the respective planetary gear sets 220A, 220B and 220C. For illustrative purposes, each of the gear reduction units 40A, 40B and 40C are shown coupled to respective CV shafts and wheel shafts. In practice, it is contemplated that the wheel-end planetary reducers 40A, 40B, 40C will be stand-alone self-contained assemblies ready for connecting to respective CV shafts and wheel shafts already existing in the vehicle 10. Similarly, FIG. 7 illustrates three first gear reduction units 44A1, 44A2 and 44A3, each having a distinct gear ratio offered by a respective gear set (not specifically shown).

As can be appreciated, the system disclosed herein is modular whereby a user can swap out any of the first or second gear reduction units such as to achieve a different gear ratio that is better suited for a given application (e.g., off-roading, highway, etc.). It is appreciated that each of the second gear reduction units 42A1, 42A2 and 42A3 are provided in pairs. In this regard, a user would select two common wheel-end reducers (such as 42A1 having the same gear reduction ratio) for installing at the drive wheels 70A, 70B. Similarly, each of the first gear reduction units 44A1, 44A2 and 44A3 are provided in pairs. In this regard, a user would select two common reducers (such as 44A1) to be installed at the respective outputs of the electric motors 44A, 44B (FIG. 1), or electric motor 50 (FIG. 2).

Referring back to FIG. 5, the planetary gear set 220 of the wheel-end planetary reducer 40 includes a sun gear 230, a carrier 234 that supports a plurality of pinion gears 238, and a ring gear 240. In the example shown, the sun gear is driven by a CV shaft 244. The CV shaft 244 is also referred to herein generally as a drive shaft. A wheel shaft 250 acts as an output of the planetary gear set 220 and drives the drive wheel 70A. The CV shaft 244 acts as an input shaft to the planetary gear set 220. A first bearing 254 supports the sun gear 230. A pair of second bearings 258A, 258B support the wheel shaft 250. A first seal 264 receives the sub gear 230. A second seal 268 receives the wheel shaft 250. As the wheel-end planetary reducer 40 is a modular component, the seals 264 and 268 retain fluid within the unit.

A first coupling 270 couples the CV shaft 244 to the sun gear 230. A second coupling 272 couples the wheel shaft 250 to the drive wheel 70. The first and second couplings 270, 272 can be any couplings suitable to connect the respective components. It is contemplated that the couplings can include one or more flanges, snap rings and/or fasteners that mechanically connect the respective components. Those skilled in the art will appreciate that the first and second couplings 270, 272 can be configured in any manner suitable to couple the respective components while allowing ease of serviceability.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric drive system for an electrified vehicle, the electric drive system comprising:
a driveline including a first drive shaft that drives a first drive wheel and a second drive shaft that drives a second drive wheel;
a first electric drive module having a first primary output shaft; and
a first gear reduction assembly comprising:
a first gear reduction unit driven by the first primary output shaft; and
a second gear reduction unit provided at the first drive wheel, the first and second gear reduction units providing a collective gear reduction from the first primary output shaft, through the first gear reduction unit, through the first drive shaft, through the second gear reduction and to a first wheel shaft at the first drive wheel.

2. The electric drive system of claim 2, further comprising:
a second gear reduction assembly comprising:
a third gear reduction unit driven by a second primary output shaft of the first electric drive module; and
a fourth gear reduction unit provided at the second drive wheel, the third and fourth gear reduction units providing a collective gear reduction from the second primary output shaft, through the third gear reduction unit, through the second drive shaft, through the fourth gear reduction unit and to a second wheel shaft at the second drive wheel.

3. The electric drive system of claim 2, wherein the first, second, third and fourth gear reduction units are modular and removable relative to the respective drive axles, drive wheels and first electric drive module.

4. The electric drive system of claim 1, wherein the second gear reduction unit is a planetary reducer that comprises a first housing that houses a planetary gear set including a sun gear, a carrier that supports a plurality of pinion gears, and a ring gear.

5. The electric drive system of claim 4, further comprising a first coupling that couples the first drive shaft to the sun gear.

6. The electric drive system of claim 5, further comprising a second coupling that couples the first wheel shaft to the first drive wheel.

7. The electric drive system of claim 1, wherein the fourth gear reduction unit is a planetary reducer that comprises a second housing that houses a planetary gear set including a sun gear, a carrier that supports a plurality of pinion gears, and a ring gear.

8. The electric drive system of claim 6, further comprising a first bearing that supports the sun gear.

9. The electric drive system of claim 8, further comprising at least one second bearing that supports the first wheel shaft.

10. The electric drive system of claim 1, further comprising:
a second electric motor; and
a third electric motor positioned between the first and second electric motors.

11. The electric drive system of claim 10, wherein the first, second and third electric motors are co-axially arranged on a rear axle of the electrified vehicle.

12. The electric drive system of claim 10, wherein the first, second and third electric motors are co-axially arranged on a front axle of the electrified vehicle.

13. The electric drive system of claim 10, wherein the first electric motor drives the first drive shaft and the second electric motor drives the second drive shaft, the first and second electric motors providing torque vectoring between the first and second drive wheels.
